(19) United States
(12) Patent Application Publication
(10) Pub. No.: US 2020/0031238 A1
(43) Pub. Date: Jan. 30, 2020

(54) Vehicle-Solar-Grid Integration for Back up Power

(71) Applicant: Paul Harriman Kydd, Lawrenceville, NJ (US)

(72) Inventor: Paul Harriman Kydd, Lawrenceville, NJ (US)

(21) Appl. No.: 16/044,683

(22) Filed: Jul. 25, 2018

(51) Int. Cl. B60L 11/18; H02J 9/06; H02J 3/38

(52) U.S. Cl. CPC B60L 11/1842; H02J 9/06; B60L 2210/40; B60L 2210/30; H02J 3/383

(57) ABSTRACT

This invention consists of a method and apparatus to use an electric vehicle main propulsion battery to provide back up power during grid outages. It relies on simultaneous AC connection through an EVSE to the conventionally provided on-board vehicle battery charger and DC connection from the vehicle main propulsion battery to a stationary, ground-based inverter to provide bidirectional power flow to and from the vehicle. this bidirectional capability can provide back up power during grid outages and remunerative ancillary services to the grid. The DC connection to the vehicle battery may be indirectly through the on-board DC-DC converter and the low voltage accessory battery system or direct to the high voltage main propulsion battery. If the AC power source is connected to a solar array, the back up system can keep the array functioning through outages for an indefinite time and charge the vehicle for continued use.

### CROSS-REFERENCE TO RELATED APPLICATIONS

This application is related to U.S. patent application “Vehicle-Solar-Grid Integration” Ser. No. 14/101,423 filed Dec. 10, 2013, now granted as U.S. Pat. No. 9,566,867 B2, Feb. 14, 2017, by the present inventor, and Provisional patent applications “Bidirectional Power Electronic Interface” No. 61/889,067, filed Oct. 10, 2013, “Bidirectional Power Electronic Interface with Sustaining Power” 61/921,583, filed Dec. 30, 2013, “Vehicle-Solar-Grid Integration with Supplementary Battery” 62/050,819, filed Sep. 16, 2014, “Low-Cost EVPV for Vehicle-Solar-Grid Integration”, 62/297,462, filed Feb. 19, 2016, “Minimum Cost EVPV for Vehicle-Solar-Grid Integration” 62/299,756, filed Feb. 25, 2016, filed as nonprovisional patent application Ser. No. 15/441,484, Feb. 24, 2017, and “Vehicle-Solar-Grid Integration for Back up Power” 62/465,424 filed Mar. 1, 2017 by the present inventor and “Multiple Load Micro-Grid Implementation of Vehicle-Solar-Grid Integration” 62/320,701, filed Apr. 11, 2016, by The Present Inventor and Brian R. Hamilton of Cranbury, N.J., and Chris A. Martin of Media, Pa.

### FEDERALLY SPONSORED RESEARCH

None

### CITED LITERATURE

SAE J-1772 Standard for Electric Vehicle Service Equipments revised October 2012, p 32.
IEEE Standard 1547 Net metering interconnection to the grid
reuters.com/article/us-newmotion-m-a-shell/shell-buys-newmotion-charging-network-in-first-electric-vehicle-deal-idUSKBN1CH1QV
nuvve-give-platform-the-worlds-largest-aggregator-participates-in-tennets-frequency-regulation-market-in-the-netherlands-300262624
Kempton, Willett et al, SAE Technical Paper 2015-01-0306, 2015
ucsdnews.ucsd.edu/pressrelease/nuvve_and_uc_san_diego_to_demonstrate_vehicle_to_grid_technology
“Open Vehicle-Grid Integration Platform: Phase 1 Development Uptake, EPRI document 3002004037, Dec. 31, 2014.
insideevs.com/nissan-leaf-to-home-prepped-for-commercialization-in-u-s-will-be-nissans-primary-focus-at-2017-naias/
www.ovoenergy.com/electric-cars/vehicle-to-grid-charger
“Vehicle-to-Grid Project Reveals Challenges of The Early Days”, T. Ewing, Charged Magazine, January-February, 2018, p. 74-79.

### CITED PATENTS

### AC-Coupled Systems

Frohmann et al U.S. Pat. No. 9,584,047 Feb. 8, 2017, “Bidirectional power converter having a charger and export modes of operation.
Choi et al U.S. Pat. No. 9,481,259 Nov. 1, 2016, “Bidirectional vehicle charging apparatus and operating method.
Zhao et al (BYD) U.S. Pat. No. 9,290,105 Mar. 22, 2016, “Electric Vehicle and active discharging system”
Li et al (BYD) U.S. Pat. No. 9,272,629 Mar. 1, 2016, “Power system switching between charge discharge function and driving function and EV comprising the same”
Yang et al (BYD) U.S. Pat. No. 9,260,022 Feb. 16, 2016, “Electric Vehicle and power system and motor controller for electric vehicle”
Kim et al (Hyudai) U.S. Pat. No. 9,878,624 Sep. 5, 2017, “Apparatus for converting power of electric vehicle.
Lambert et al, (Quebec Hydro) US Patent Application 2017/0050,529 Feb. 23, 2017, “Bidirectional charging system for electric vehicles”.
Yang et al (BYD) US Patent Application 2016/0368,390, Dec. 22, 2016, “Vehicle Mutual charging system and charging connector”
Zhao et al, (BYD) US Patent Application 2015/0008,850 Jan. 8, 2015, Electric vehicle and active discharging system for electric vehicle”
Li et al (BYD) US Patent Application 2014/0354,195 Dec. 4, 2014, “Power system switching between charge discharge function”

### DC-Coupled Systems

Harty et al (Honda) U.S. Pat. No. 9,153,847 Oct. 6, 2015 “Grid connected solar battery charging device for home”
Kang et al (Hyundai) US Patent Application 2013/0328,527 Dec. 12, 2013 “Apparatus for bidirectional power supply between electric vehicle and smart grid and of bidirectionally supplying electric power employing the same”

### Autonomous Systems

Miftakov et al (Electric MotorWerks) U.S. Pat. No. 9,987,941 Jun. 5, 2018, “Systems and methods for autonomous response to grid conditions by EV charging stations”
Pratt et al (Battelle) U.S. Pat. No. 9,753,440 Sep. 5, 2017, and 8,700,225 Apr. 15, 2014 “Grid regulation services for energy storage devices based on grid frequency”

### BACKGROUND OF THE INVENTION

Electric vehicles with large storage batteries represent an underutilized resource that can serve to provide back up power to residences and businesses during grid outages. They can also stabilize the electric utility grid and reduce the requirement for additional investment in distribution and transmission equipment, if they can be remotely directed to take or provide AC power. The communication technology for the remote control exists, together with an existing market for ancillary services to the grid. A controllable, bidirectional energy path between the vehicle and the grid can provide the building/electric vehicle owner with revenue.

An example of such an ancillary service is frequency regulation in which battery storage can take excess power or provide needed power instantly on request from the Independent System Organization or Regional Transmission Organization (ISO/RTO) responsible for grid stability. The ISO/RTOs pay for this ancillary service in a daily auction market. Another service is demand response in which the battery can stop charging at periods of peak demand when the power is needed elsewhere on the grid. This service is also recompensed by the RTO/ISO.

The aggregation of electric vehicles to provide ancillary services to the grid has been piloted on a relatively large scale in the Netherlands by New Mobility (recently acquired by Shell Oil) with 300,000 electric charging stations and implementing technology developed at the University of Delaware and licensed to NUUVe. The NUUVe technology embodies an on-board bidirectional charger/inverter on the vehicle that can accept or provide AC power through a standard SAE J 1772 connection. The NUUVe technology is also the subject of a 50-vehicle test program at the University of California at San Diego. A trial of V2G technology at the Los Angeles Air Force Base at el Segundo, Calif., was successful a producing ancillary service revenue from a fleet of 29 vehicles with some difficulty. The provision of on-board inverters is problematic in that none of the major automobile OEMs have adopted this route, and the inverters need to meet stringent Underwriters Laboratory registration requirements and IEEE 1547 grid-interconnection requirements. The Electric Power Research Institute has begun a project to provide a standard utility interface for V2G based on the open ADR 2.0b standard.

For commercial and industrial vehicle owners, the vehicle battery can provide power to offset peak demand during the daytime and thus reduce the monthly demand charge imposed by the local distribution company. There is an opportunity for energy arbitrage in which the vehicle is charged at night when prices are low and operated or partially discharged during the day when the electric power is worth more.

For individual vehicle owners access to the energy stored in the vehicle battery can provides a back up power supply during grid outages to maintain essential home services such as heating and water pumps. This capability is particularly valuable in conjunction with a solar photovoltaic array which can provide power to keep the battery and the vehicle charged during outages and which in turn can be kept operating by “islanding” from the grid rather than shutting down as required by IEEE standard 1547 to avoid putting power back on the grid during an outage.

Nissan Motors has developed the “Leaf-to-Home” system to connect the DC quick charge port on a Nissan Leaf to a stationary inverter to provide back up power. This system has been offered in Japan for a number of years and may be introduced into the United States. As the xStorage system it is described as involving a stationary battery pack and inverter connected to the vehicle quick charge port and capable of bidirectional operation. It can be integrated with the utility for V2G and allegedly can provide free charging, presumably by energy arbitrage, buying energy at low cost off peak and giving some of it back at higher price on peak. The Nissan Leaf and e N200 Van are capable of bidirectional DC power flow. OVO Energy is piloting a similar system with Nissan vehicles in the UK.

### BRIEF SUMMARY OF THE INVENTION

This invention comprises a novel method of interfacing a large battery pack, as in an electric vehicle, with an inverter to provide back up emergency power during grid outages and ancillary services to the electric utility grid, and the apparatus to accomplish the integration. The same apparatus may be integrated with a solar photovoltaic installation to keep the solar PV operating during outages to provide a back up power source of indefinite duration or even to allow for off-the-grid living.

It is an object of this invention to provide a bidirectional connection to an electric vehicle to allow the vehicle main propulsion battery to serve as electric energy storage accessible to both the electric power grid and to the vehicle owner. In order to accommodate the widest range of electric vehicles without requiring special OEM equipment or on board modifications, this invention utilizes both Direct Current (DC) and Alternating Current (AC) connections to the vehicle, simultaneously. The DC connection permits the withdrawal of electric energy from the vehicle's main battery and may be through the on board DC-DC converter and the 12 V accessory system or direct from the main propulsion battery through a factory-installed quick charge port. The AC connection provides electric energy to the main battery through a conventional Electric Vehicle Service Equipment (EVSE) connected by the standard SAE J 1772 plug and receptacle. The combination of DC and AC connections can be programmed to maintain the vehicle in a suitable state of charge to provide the driving range needed by the owner using power from the grid at the optimum time to minimize cost, and to provide ancillary services to the grid to generate revenue to offset the cost of the vehicle and its energy supply.

For both ancillary service and owner service it is an advantage to have the battery connected at all times to maximize revenue and convenience. However, by the nature of a vehicle, the vehicle battery is going to be disconnected when the vehicle is in use. This may be for as little as an hour or two or as much as 8 or 10 hours per day, depending on use of the vehicle. An auxiliary stationary battery is provided to maintain continuity of service while the vehicle is in use. This and the inverter provides the bulk of the electric power required for motor starting and transient high loads, while the vehicle battery provides the bulk of the electric energy needed to maintain essential services during a prolonged outage.

There is an active patent literature on this subject, mostly on AC-coupled systems with on board inverters like that developed originally by AC Propulsion of San Dimas, Calif., which was picked up by the University of Delaware and is now licensed to NUUVe. Many of these patents are assigned to BYD the Chinese electric vehicle company. There is a patent and an application for DC-coupled systems. Harty (assigned to Honda) shows DC links to a vehicle and a solar array feeding a single inverter to interface with the grid. Kang (assigned to Hyundai) in an application published in 2013 shows a bidirectional DC connection to a vehicle. There appear to be no references to coupling to both the AC and DC ports on a vehicle, as proposed in this invention.

The present inventor has filed provisional and nonprovisional patent applications on a similar concept (“Minimum Cost EVPV for Vehicle-Solar-Grid Integration” 62/299,756, filed Feb. 25, 2016, filed as nonprovisional patent application Ser. No. 15/441,484, Feb. 24, 2017). The distinction between the present application and the earlier one is that the earlier application relied on an already-installed, grid-tied solar photovoltaic inverter to convert DC power from the vehicle battery to AC for distribution, whereas the present invention relies on a separate ground-based inverter and is linked to the solar PV system, if any, only as a source of electric energy storage for the solar system and as an AC signal to keep the solar system operational in times of outage. The currently proposed system does not depend on the solar inverter or use it for any but solar energy.

### BRIEF DESCRIPTION OF THE DRAWINGS

The means by which these objectives are achieved by the present invention are illustrated in the accompanying Figures:

FIG. 1 is a schematic drawing of the apparatus of this invention in a typical installation wherein the DC connection to the vehicle is achieved through the low voltage accessory battery of the vehicle illustrating the method of operation.

FIG. 1A 1 is a schematic drawing of the apparatus of this invention in a typical installation wherein the DC connection to the vehicle is achieved through the quick charge port leading directly to the high voltage main propulsion battery of the vehicle illustrating the method of operation.

FIG. 2 is a schematic drawing of the apparatus of this invention integrated with a solar photovoltaic installation in which the solar system will shut down normally in an outage.

FIG. 2A is a schematic drawing of the apparatus of this invention integrated with a solar photovoltaic installation in such a way as to island the solar system to maintain emergency power over longer periods than the vehicle battery can support, and in which the solar system can recharge the vehicle.

### DETAILED DESCRIPTION OF THE INVENTION THE PREFERRED EMBODIMENT

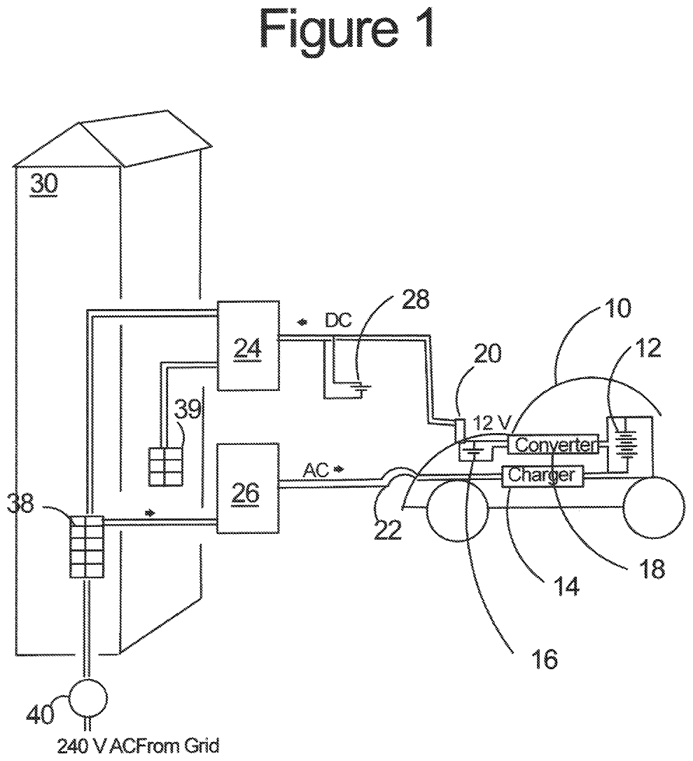

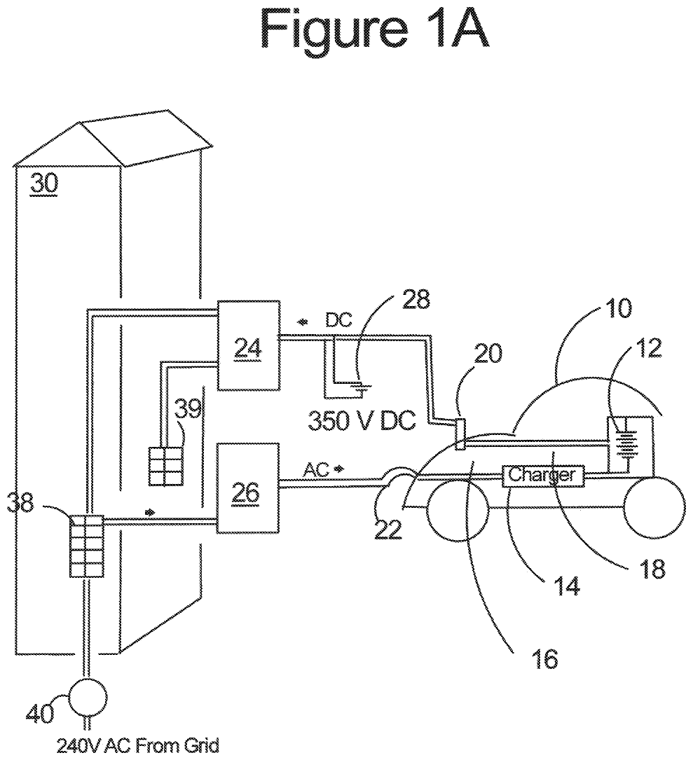

In FIG. 1 electric vehicle 10 is powered by main propulsion battery 12, which is recharged with AC electric energy from the grid by on-board charger 14. Twelve Volt accessory battery 16 is recharged from the main battery 12 via DC-DC converter 18, as is conventional in electric vehicles. By the method of this invention accessory battery 16 is connected via plug connector 20 to inverter 24, in parallel with 12 Volt stationary battery 28. AC power supplied from the grid through meter 40 and distribution panel 38 of building 30 normally passes through inverter 24 to back up power power panel 39 to supply critical loads at either 240 V or 120 V. In the event of a power outage, an Automatic Transfer Switch (ATS) in inverter 24 disconnects the back up power panel 39 from the grid supply 40 and inverts DC power from batteries 28 and 16 into AC power to continue to supply back up panel 39.

Twelve-Volt vehicle accessory battery 16 is supplemented by stationary twelve-Volt battery 28 to maintain back up power when the vehicle is disconnected. Battery 28 also provides more electric power (kW) than the vehicle 12 V battery 16 can conveniently supply for motor starting and other transient loads. Battery 28 may be recharged from inverter 24, if the latter is capable of inverter/charger operation. Alternatively battery 28 may be recharged from the vehicle by leaving the two connected, and turning on the vehicle.

Accessory 12 V battery 16 is continually recharged from main propulsion battery 12 via DC-DC converter 18. By utilizing this route a much larger supply of electric energy (kWh) than batteries 16 and 28 can provide can be accessed. In an outage the vehicle may be connected by plug 20 and turned on to provide all of the energy in propulsion battery 12 to back up power panel 39 through inverter 24. Since battery 16 and DC-DC converter 18 are providing primarily energy and the electric power is limited to less than a kilowatt, plug 20 carries less than 83 Amperes of current and can be a simple pair of alligator clips. As vehicle accessory voltages rise to 48 V, as they are expected to do, the power of this connection may increase and the current will decrease, still allowing a relatively informal connection to serve adequately.

In normal operation main propulsion battery 12 is recharged by AC power supplied to on board charger 14 via the conventional J1772 level 1 or level 2 connector 22 from Electric Vehicle Service Equipment (EVSE) 26 and panel 38 in the usual way. The essence of this invention is to use both the AC connection to recharge the vehicle in the usual way and the DC connection to allow DC power to flow to an off-board inverter to achieve bidirectional power flow from a maximum variety of electric vehicles with minimum modification.

In FIG. 1A the same purpose is served, except that the DC connection to the main propulsion battery 12 of the vehicle is direct through a quick charge port 20 instead of indirectly passing through the accessory battery system. Port 20 may be any of the standard DC quick charge standards such the Japanese standard CHAdeMO connector or the SAE CCS Combo connector used in German and US-made vehicles. The CCS is convenient because it can connect both the AC and DC circuits through a single plug and receptacle. Tesla vehicles accomplish the same objective through the J-1772 connector by switching between AC regular and DC fast charging modes depending on signals relayed from the charger specifying its nature. There is an SAE J-1772 AC Level 2, DC Level 1 standard for this type of single connection, dual mode charging also.

Connection through the quick charge port allows for much higher power to be drawn from the main propulsion battery than by the indirect connection shown in FIG. 1. This is ideal for supporting large loads such as air conditioners in residences and businesses and in providing ancillary services to the grid. However, a very close match between the vehicle batteries and fixed battery 28 is necessary, since they are connected in parallel by the DC link 20. The use of vehicle batteries that have lost some of their capacity for stationary provision of ancillary services has been discussed in the literature and would be ideal in this application as offered by the Nissan xStorage system.

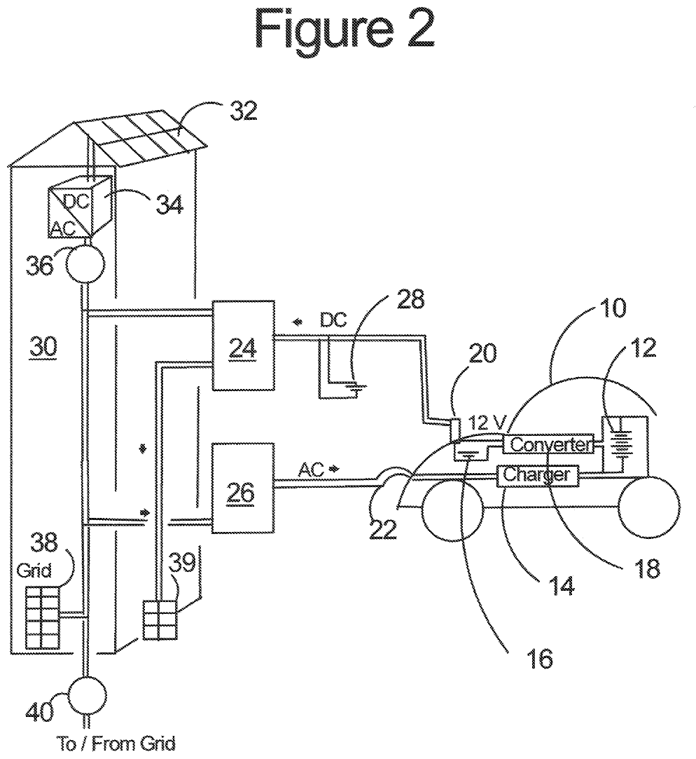

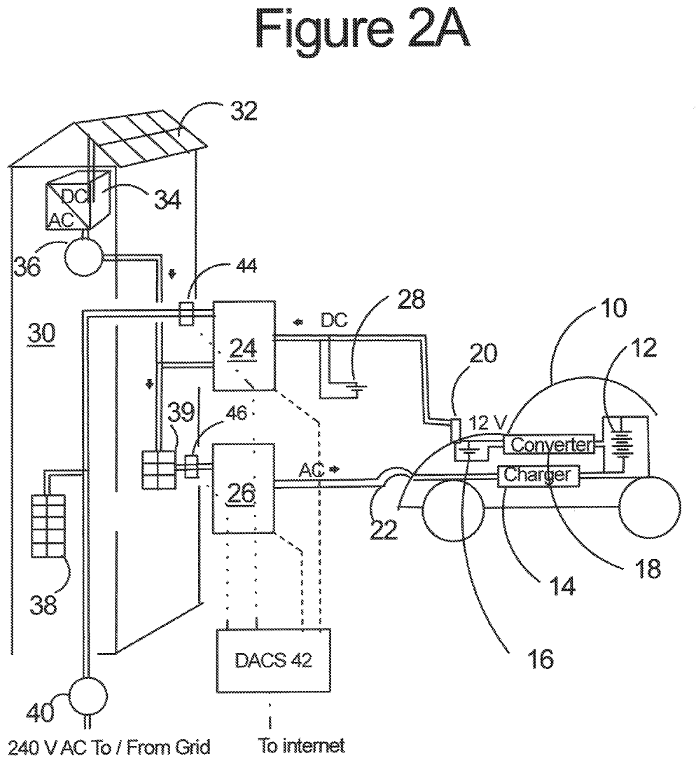

FIG. 2 shows this invention integrated with a solar photovoltaic power system. Solar array 32 on building 30 is connected to grid-tied inverter 34 and solar energy meter 36 to distribution panel 38 and net meter 40 allowing bidirectional flow of power from the grid to/from building 30. In the event of a power outage, inverter 34 isolates array 32 from the grid to prevent hazardous back flow of power. Grid-tied solar PV inverters contain “anti-islanding” features and are IEEE 1547 compliant for connection to the grid. This means that in an outage the PV system shuts down to avoid feeding power back onto the grid and endangering linemen attempting to fix the problem. Inverter 24 also contains an Automatic Transfer Switch, which is 1547 compliant and isolates the grid. However, it continues to provide power to back up panel 39 by inverting DC power from vehicle 10 and battery 28.

In FIG. 2A the arrangement is modified to connect the solar system to the output of inverter 24. Now in case of an outage, inverter 24 isolates from the grid as before, but solar inverter 34 stays connected to inverter 24 providing solar power to back up panel 39. This permits back up power to be supplied indefinitely as long as the sun shines, and provides for higher loads to be serviced by back up panel 39 such as the EVSE. By proper management of the solar resource and the DC storage in the main propulsion battery of the electric vehicle, all of the available solar energy can be captured to maintain a relatively normal lifestyle during an outage of whatever duration.

Control and switching equipment may be added to the installation of this invention to accomplish ancillary service functions to the grid such as demand response and frequency regulation. These functions are controlled by modulating the operation of Inverter 24 and EVSE 26. These regulation control means are in turn interfaced to grid RTO/ISO ancillary service requests via Data Acquisition and Control System (DACS) 42. DACS 42 may control EVSE 26 to permit charging the battery pack only at times of favorable electricity prices to achieve Time of Use charging and to interrupt charging during periods of high demand to achieve demand management. DACS 42 may control the inverter 24 to take power from the batteries 16 and 28 at periods of high demand to service local loads through panel 38 or to supply power to the grid through net meter 40 where permitted. Data on the response of the system from current transformers 44 and 46 are fed through DACS 42 to the RTO/ISO via the internet to confirm compliance with ISO requests for ancillary service.

In operation DACS 42 will be a locally-sited micro computer with communication via the internet or otherwise to frequency regulation and demand response signals from the local RTO/ISO which are managed by an off-site aggregator. The aggregator combines individual vehicles to provide a minimum capability of use to the ISO in maintaining grid stability, typically 0.1 to 1.0 megawatts, (20 to 200 vehicles). The provision of ancillary service requires that the power consumed or fed to the grid be proportional to the need transmitted by the ISO. This can be achieved by using proportionate controls on the inverter 24 and EVSE 26 as enabled by the J-1772 protocol for electric vehicle charging. Alternatively the charger and inverter may be controlled by simple on/off switches and the power of the aggregate controlled by the aggregator to provide a proportional output determined by how many of the vehicles are switched on at any time. Data flows from the DACS through the aggregator to the ISO confirming performance, and payments flow from the ISO to the aggregator and on to the vehicle owner or other financial beneficiary.

DACS 42 also may receive requests from the vehicle operator as to the required state of charge needed to fulfill the expected mission of the vehicle and provide data on the current status.

In addition to providing demand response service to the utility grid, the flow of power from vehicle 10 to building 30 can be controlled by DACS 42 to offset peak demands for power and thus reduce the demand charge on the owner's monthly utility bill. This charge typically amounts to $10 to $20 per kW measured in any 15 minute period in the month and the peak demand charge can be billed for 6 months to a year after it is incurred. There is thus a substantial incentive to reduce demand which inverter 24 can do, provided that it has access to battery storage.

In addition to controlling EVSE 26 to accomplish demand charge management and demand response, DACS 42 can control other loads in building 30 such as hot water heating and air conditioning to accomplish the same objective with a larger impact than from vehicle charging alone.

I claim:

1. The method of simultaneously connecting an electric vehicle to a building or other source and consumer of electric energy with both the commercially available AC battery charging circuit provided with the vehicle and a DC power extraction circuit comprising a stationary, ground-based inverter, such that the vehicle can accept or provide bidirectional power flow to recharge the vehicle battery and provide backup power to the building in a grid outage.

2. The method of claim 1 in which the bidirectional flow of electric energy from and to the vehicle can be controlled and used to provide ancillary services to the grid and to the building/vehicle owner by control of the AC power flow to the vehicle and the DC power flow from the vehicle.

3. The method of claim 1 in which the bidirectional system provides electric energy storage to a photovoltaic system by charging the electric vehicle battery.

4. The method of claim 1 in which the bidirectional system provides a continuing AC signal by interconnection of the vehicle battery through an inverter to keep the PV system operational during grid outages.

5. An apparatus for bidirectional power flow to and from an electric vehicle comprising simultaneous connection to both the on board AC battery charger provided with the vehicle through a conventional Electric Vehicle Service Equipment (EVSE) to recharge the vehicle battery and to the DC battery of the vehicle through a stationary, ground-based inverter to provide back up power to the building in the event of a grid outage.

6. The apparatus of claim 5 in which the DC connection is made indirectly through the low voltage accessory battery in the electric vehicle, which is in turn charged through an on-board DC-DC converter from the high voltage main propulsion battery.

7. The apparatus of claim 5 in which the DC connection is made directly with the high voltage main propulsion battery through a DC quick charge port.

8. The apparatus of claim 5 in which the inverter is connected to an emergency power panel in a building to provide uninterrupted power to critical loads during an outage.

9. The apparatus of claim 5 in which the inverter is equipped with an automatic or manual transfer switch to isolate the grid connection from the apparatus in event of a power failure so that the vehicle battery can provide uninterrupted back-up power to the building.

10. The apparatus of claim 5 in which the DC connection to the vehicle is selected from among the group: Standard DC quick charge connectors conforming to the SAE CCS, CHAdeMO, Tesla Supercharger, or SAE J-1772 level 2 AC/level 1 DC protocols.

11. The apparatus of claim 5 in which a stationary battery of appropriate voltage is connected in parallel with the DC connection to the vehicle to maintain back up power through the inverter when the vehicle is not present, and to supplement the power and capacity of the vehicle accessory battery if used.

12. The apparatus of claim 5 in which control means are included to permit control of the output of the inverter in up regulation and the EVSE and the vehicle charger in down regulation and can provide frequency regulation, demand response, time of use pricing and demand charge management functions.

13. The apparatus of claim 5 containing a local Data Acquisition and Control System (DACS) which can be programmed to control the functions of vehicle charging and providing ancillary service to the grid and back up power in emergencies.

14. The apparatus of claim 5 containing one or more revenue-grade meters, which are used to confirm performance of ancillary services to the grid.

15. The apparatus of claim 5 containing communication means which permit ancillary service commands to be supplied to the apparatus and the resulting data to be supplied to the grid independent system organization (ISO).

16. The apparatus of claim 5 connected to a solar photovoltaic power system in such a way that photoelectric energy can be used to recharge the vehicle battery and the auxiliary battery of claim 11 providing energy storage capability to the photovoltaic system.

17. The apparatus of claim 5 connected to a solar photovoltaic power system with a grid-tied inverter in such a way as to island the solar PV system to enable it to provide back up power indefinitely during power outages.
